(19) United States
(12) Patent Application Publication
(10) Pub. No.: US 2022/0302774 A1
(43) Pub. Date: Sep. 22, 2022

(54) Electric Motor With Improved Engine Utilization

(71) Applicant: ebm-papst Mulfingen GmbH & Co. KG, Mulfingen (DE)

(72) Inventors: Jochen HÄFNER, Blaufelden (DE); Werner Müller, Mulfingen-Seidelklingen (DE); Stephan Nadig, Zweiflingen-Pfahlbach (DE); Erich Pollok, Niederstetten (DE); Gerhard Sturm, Mulfingen (DE); Martin Baun, Mulfingen (DE)

(21) Appl. No.: 17/695,378

(22) Filed: Mar. 15, 2022

(30) Foreign Application Priority Data
Mar. 16, 2021 (DE) 10 2021 106 341.8

(51) Int. Cl. H02K 1/16; H02K 3/32; H02K 7/00; H02K 9/02

(52) U.S. Cl. CPC H02K 1/165; H02K 3/325; H02K 7/003; H02K 9/02

(57) ABSTRACT

An external rotor motor (1) has a stator (10) with a stator lamination (11), a shaft (20) and a rotor bell (30). The shaft (20) is attached in a non-rotatable manner and extends in the axial direction (A) of the motor. The rotor bell (30) is arranged such that it can rotate relative to the non-rotatable shaft (20). The rotor bell (30) is rotatably mounted on the shaft (20) by at least one first stator-side bearing shield (31) and a second rotor-side bearing shield (32). The stator (10) has a modular construction with a plurality of individual teeth (12) to attach the stator windings (16). The individual teeth (12) are attached to one another in the direction of rotation and/or to a central stator body (17) by a respective fastening contour (15, 18, 18a, 19, 19a), through which a fastening pin (15) extends.

### CROSS-REFERENCE TO RELATED APPLICATION

This application claims the benefit and priority of German Application No. 10 2021 106 341.8, filed Mar. 16, 2021. The entire disclosure of the above application is incorporated herein by reference.

### FIELD

The disclosure relates to an electric motor, particularly an external rotor motor, with a stator and a rotor bell that can be rotated relative to the stator.

### BACKGROUND

In high-speed electric motors, and as a matter of principle in external rotor motors with improved motor utilization, adequate cooling is of great importance in order to ensure optimum motor utilization.

A wide variety of cooling concepts are known from the prior art for external rotor motors. Although the motor utilization is generally not optimal, such a motor does not ensure optimal operation from an economic standpoint.

A stator or stand for an electric motor usually consists inter alia of a stator lamination. The stator lamination is formed from individual electrical steel sheets. In addition, the stator lamination has a number of stator teeth (or webs) that extend radially into the interior of the stator lamination or radially outward in the case of stator laminations that are slotted on the outside. There are intermediate spaces in the form of stator slots between the individual stator teeth. The stator teeth are used to hold stator coils. The goal is always optimal copper filling in the slots.

It is known to execute a winding around teeth of a laminated core in a stator of an electric motor. The laminated core is produced by welding, for example. For electrical insulation, insulation is inserted between the winding region and the laminated core.

Solutions are presented in the following as examples that show that known measures in other motor concepts cannot be easily transferred to an external rotor motor in order to improve motor utilization.

Patent specification EP 2 015 426 B mentions a stator for a drive device only as an example. Such a stator has two axial stator ends. Each has a connection element such as an end shield or cover. Moreover, the interior of the stator has a number of stator teeth that extend over the entire length of the stator and are subdivided by winding slots. One very fundamental problem is the production of thin insulation wall thicknesses. The lower copper fill factor is also disadvantageous in the case of thick insulations. Thus, these concepts and solutions offer no suggestion as to how the motor utilization and the fill factor of an external rotor motor might be optimized.

There are also developments in the prior art with regard to segmented stator laminations. These relate more to the ease of assembly and the possibility of winding as such and less to the optimization of the copper filling and motor utilization.

Solutions for this are known from the prior art, for example, where the winding can only be inserted by subsequent or simultaneous joining of segmented stator segments. The joining of segmented stator laminations results in an additional air gap in the connection point and often also in unwanted electrical connections between different levels of the laminated cores. This is caused by a slight axial offset or flash formation during joining. Additional air gaps lead to an increased magnetizing current requirement of the electrical steel sheet. Also, electrical connections between the sheet levels result in additional eddy currents.

A need exists, however, especially for external rotor motors with high torques and high speeds to provide an optimized overall motor concept. In addition, it should be possible to accommodate a cooling mechanism with the motor utilization optimized. Thus, it can no longer be implemented efficiently and economically with so-called standard external rotor motors with a rotating rotor bell using the measures that are known from the prior art.

The disclosure is therefore based on the object of overcoming the aforementioned drawbacks in the prior art. It provides an electric motor, particularly an external rotor motor, with optimized motor utilization for high torques and with a likewise improved cooling concept.

### SUMMARY

This object is achieved by an external rotor motor including a stator with a stator lamination, a shaft and a rotor bell. The shaft is attached in a non-rotatable manner and extends in the axial direction (A) of the motor. The rotor bell is arranged to rotate relative to the non-rotatable shaft. The rotor bell is rotatably mounted on the shaft by at least one first stator-side bearing shield and a second rotor-side bearing shield. The stator has a modular construction including a plurality of individual teeth for attaching stator windings. The individual teeth are attached to one another in the direction of rotation and/or to a central stator body by a respective fastening contour. A fastening pin extends through the contour.

According to the disclosure, an electric motor, particularly an external rotor motor, comprises a stator with a stator lamination, a non-rotatably mounted shaft that extends in the axial direction A of the motor, and a rotor bell arranged to be rotatable relative to the non-rotatable shaft.

The rotor bell is rotatably mounted on the shaft by at least one first stator-side end shield. A cooling device is arranged between the shaft and the stator lamination that connects the same. Upon rotation of the motor during operation, air circulation is caused by virtue of a multitude of axial flow openings arranged in the cooling device in the circumferential direction.

The rotor bell is preferably rotatably mounted on the shaft by a second bearing shield, specifically on the rotor side. Thus, this ensures that the motor runs very smoothly.

According to the disclosure, the stator has a modular structure with a plurality of individual teeth for attaching stator windings. The individual teeth are attached to one another and/or to a central stator body in the direction of rotation by a respective fastening contour. A fastening pin, preferably a metallic pin, extends through the contour.

Due to the modular structure of the stator lamination, the individual teeth and the material consumption of the required electrical sheet material can be minimized. Punching waste can be reduced substantially compared to a one-piece stator. By virtue of an environmentally friendly impregnation of the entire stator, the modular design results in a compact unit that demonstrably meets the requirements with respect to vibration and service life.

In one preferred embodiment of the disclosure, a slot extending in the axial direction, is on one side of the individual teeth. A web, rib, or coupling web, corresponding to the cross-sectional shape of the slot, is on an opposing side. The web, rib or coupling web is designed to engage in the respective slot on the directly adjacent individual tooth in order to mechanically couple the respective individual teeth together.

It is also advantageous if groove slots, running in the axial direction, are provided within the slot.

In another preferred embodiment of the disclosure, the coupling webs, include one or more web ears that extend outward in the axial direction. They are correspondingly shaped and positioned so they engage in the respective groove slots when the respective coupling web engages in a corresponding slot. It is especially preferred if the coupling web has a substantially hollow cylindrical shape with an internal channel.

It is advantageous if the individual teeth have a rib on their radially inwardly facing side, the side opposite the outer end face oriented toward the air gap. The rib is used to connect to a cooling device that connects the individual teeth to the shaft.

In a preferred embodiment of the disclosure, the cooling device is arranged between the shaft and the stator lamination or the individual teeth. It is arranged so that when the motor rotates during operation, cooling is effected by virtue of the fact that the cooling device has a multitude of axial flow openings that are arranged in the circumferential direction.

In another preferred embodiment of the disclosure, the individual teeth have a rectangular cross section.

It is also advantageous if the winding wires of the stator windings have a rectangular cross section in order to increase the fill factor. This is a special case for externally formed winding coils. The base of the tooth is preferably modified so that it is not wider than the tooth itself. Thus, this enables the coil to be inserted.

In another preferred embodiment of the disclosure, the individual teeth have a recess on their front side facing outward in the direction of the air gap in the two regions facing toward the side edge of the tooth tip. This further enhances the smooth running of the external rotor motor.

In a likewise preferred embodiment of the disclosure, a slot seal, connecting the two individual teeth, is between each two individual teeth in the tip region in the vicinity of the slot openings. The slot seal (e.g., non-conductive, non-magnetic plastic) has a labyrinth contour when viewed in the cross-sectional direction. This ensures that any tooth vibrations that may still occur are fixed to one another by this special slot seal (labyrinth with a narrow gap) in combination with winding impregnation.

It is also advantageous if the cooling device has an inner ring connecting the shaft as well as an outer ring connecting the stator lamination. Web-shaped connecting portions, extending in the radial direction, are formed integrally with the inner ring and the outer ring between which the flow openings are provided.

As a matter of principle, all disclosed features can be combined as desired insofar as technically feasible and expedient.

Further areas of applicability will become apparent from the description provided herein. The description and specific examples in this summary are intended for purposes of illustration only and are not intended to limit the scope of the present disclosure.

### DRAWINGS

Other advantageous refinements of the disclosure are characterized in the subclaims and/or depicted in greater detail below together with the description of the preferred embodiment of the disclosure with reference to the figures.

FIG. 1 is a sectional view of an electric motor.

FIG. 2 is a perspective view of an electric motor with the viewing side of the stator end shield.

FIG. 3 is a plan view of the cooling device between the shaft and the stator lamination.

FIG. 4 is a schematic view to elucidate the modularly constructed stator as a constructed single-tooth winding with an optimized amount of copper.

FIG. 5A is a perspective view of an individual tooth with an optimized joining contour.

FIG. 5B is an engaged view like FIG. 4.

FIG. 6 is a schematic view to elucidate the design of a single tooth with a tooth shape contour to reduce the radial forces.

FIG. 7 is a schematic view of a segment of a plurality of teeth having a rectangular cross section.

FIG. 8 is a schematic view of a slot seal between two adjacent individual teeth.

### DETAILED DESCRIPTION

Example embodiments will now be described more fully with reference to the accompanying drawings.

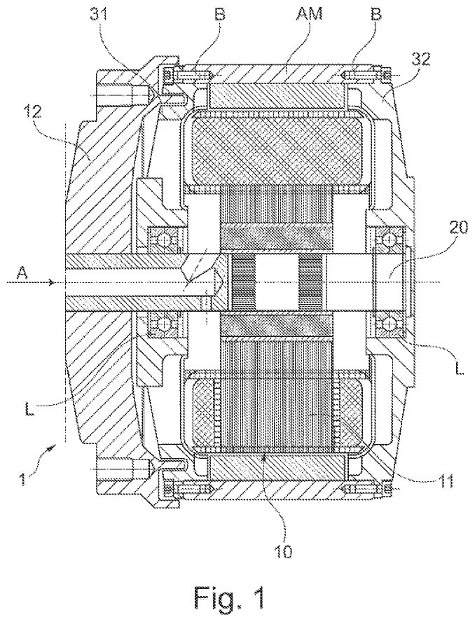

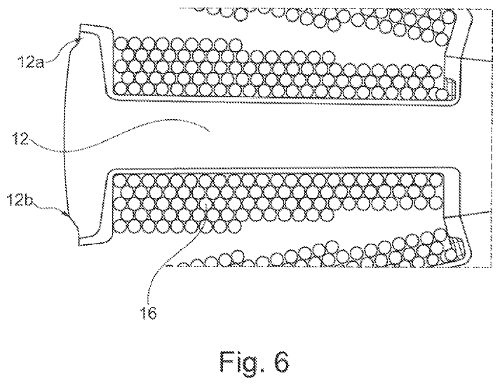

The disclosure will be explained in greater detail below on the basis of select exemplary embodiments with reference to FIGS. 1 to 8. The same reference symbols in the figures indicate structurally or functionally equivalent parts.

FIG. 1 shows a sectional view of a first exemplary embodiment of the electric motor 1 instantiated as an external rotor motor. The electric motor 1 is an external rotor motor with a stator 10, a stator lamination 11 and a shaft 20. The shaft 20 is non-rotatably mounted and extends in the axial direction A of the motor.

A rotor bell 30 is arranged such that it can rotate relative to the non-rotatable shaft 20. The rotor bell 30 has a tubular outer casing AM and a stator end shield 31. The end shield 31 is fastened to the outer casing of the rotor bell 30 with fastening means B. The stator end shield 31 is mounted on the shaft 20 by bearings L.

As can also be seen in FIG. 1, the electric motor 1 is provided with a stator flange 12.

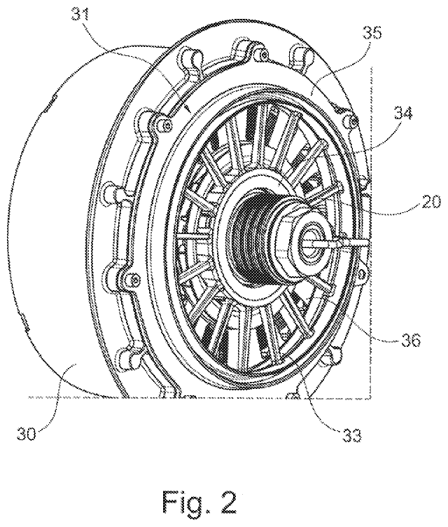

FIG. 2 shows a perspective view of an electric motor 1 with a view of the end shield 31 on the stator side.

The stator end shield 31 includes cooling wings that extend as radial spokes 33 between a central bearing portion 34 and a radially further outwardly located end shield portion 35. Openings 36 are provided between the spokes 33.

At the end of the shaft 20 there is an additional bearing L on which the rotor bell 30 is rotatably mounted by a second bearing shield 32, specifically on the rotor side. The bearing shield 32 on the rotor side is also fastened to the rotor bell 30 by fastening means B. It has a closed structure in order to ensure appropriate protection against environmental influences (e.g., ingress protection rating IP54).

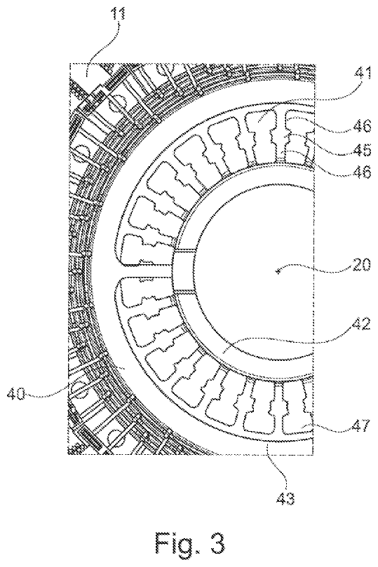

A cooling device 40, connecting these two parts, is arranged between the shaft 20 and the stator lamination 11. This is conceptually set up so that when the motor rotates during operation, the stator is cooled by virtue of the fact that the cooling device 40 has a multitude of axial flow openings 41. The openings are arranged in the circumferential direction. An air flow can thus be effected along the stator 10. Efficient cooling can be generated from the inside. The design is shown in greater detail in FIG. 3. The cooling device 40 has an inner ring 42 connecting the shaft 20 on the one hand and an outer ring 43 connecting the stator lamination 11 on the other. Both rings 42, 43 are integrally connected to one another via web-shaped connecting portions 44 that extend in the radial direction. The selected material is preferably aluminum or an aluminum alloy.

The connecting portions 44 have a central middle portion 45 which is wider in the circumferential direction in comparison to the width in the adjacent web portions 46 adjoining this middle portion 45, respectively, on both sides. The two sides curve inward in an arc. Each one has nose-shaped corner projections 47.

The effective cross section of the flow openings 41 when viewed in the axial direction is greater than the cross section of the regions located radially between the flow openings 41. A good and efficient flow is thus achieved.

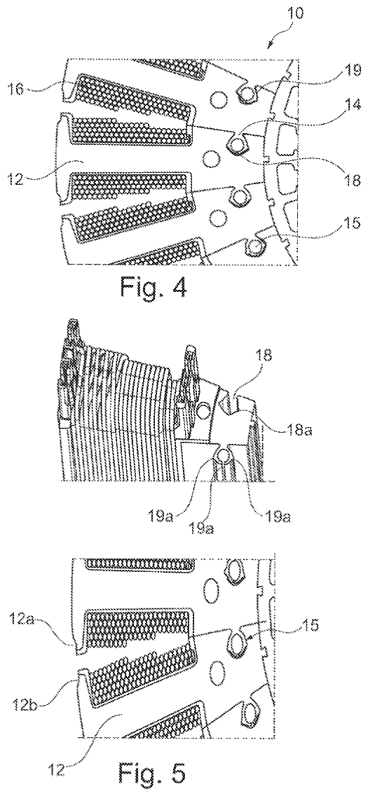

Various other core aspects of the present disclosure are shown in FIGS. 4 to 8, which are to be considered independently of the structural design of the explanations for FIGS. 1 to 3 but can also be used cumulatively therewith in order to simultaneously implement a cooling concept.

FIGS. 4 and 5A and 5B show a schematic view to elucidate the modularly constructed stator 10 as a constructed single-tooth winding with an optimized amount of copper. The stator 10 is formed by a plurality of individual teeth 12 for attaching stator windings 16. The individual teeth 12 are attached to one another in the circumferential direction by a respective fastening contour 15, 18, 18a, 19, 19a supplemented by a fastening pin 15.

FIG. 5 shows a perspective representation of a single tooth with an optimized joining contour. A slot 18, extending in the axial direction, is provided on one side of the individual teeth 12. A coupling web 19, corresponding to the cross-sectional shape of the slot 18, is provided on an opposing side. The web 19 is designed to engage in the respective slot 18 on the directly adjacent individual tooth 12 in order to mechanically couple the respective individual teeth 12 together. It can also be seen that groove slots 18a, extending in the axial direction, are provided within the slot 18. The fastening pin 15, which is preferably embodied as a steel pin, is shaped in such a way that, when it is pushed in, it creates a pressing effect and produces fixation between the coupling web 19 and the slot 18.

Correspondingly, there are three web ears 19a, extending on the outside in the axial direction, on the coupling webs 19. The ears 19a are designed in terms of shape and position such that, when the respective coupling web 19 engages in a corresponding slot 18, they engage in the respective groove slots 18a, as can be seen from the illustration to the right in FIG. 5.

Furthermore, the individual teeth 12 have a rib 12c on their radially inwardly facing side which is used for connection to the cooling device 40.

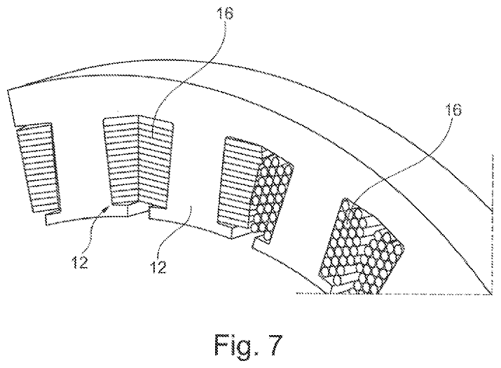

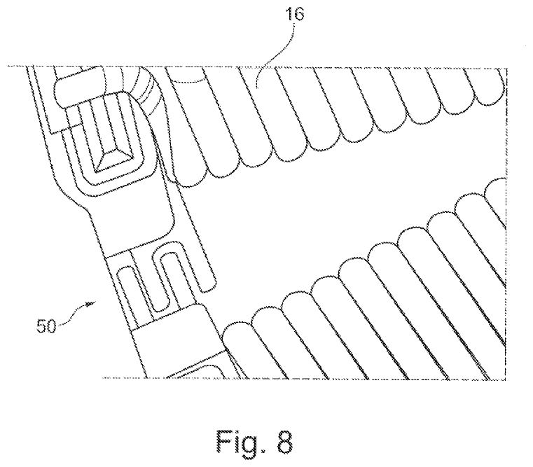

FIG. 7 shows a schematic view of the design of the teeth, the individual teeth 12 having a rectangular cross section and the winding wires of the stator windings 16 also having a rectangular cross section to increase the fill factor.

In the right-hand view of FIG. 5, it can also be seen that the individual teeth 12 have a recess 12a, 12b for reducing the radial forces on their front side facing outward in the direction of the air gap in the two regions facing toward the side edge of the tooth tip.

FIG. 8 shows an exemplary embodiment of a special slot seal. A respective slot seal 50 connecting two individual teeth 12 is provided between the two individual teeth 12 in the tip region in the vicinity of the slot openings 19. The slot seal 50 includes a labyrinth contour when viewed in the cross-sectional direction. This figure is also intended to show that the modular stator, including individual teeth, could also be designed with rectangular conductors instead of round wires, e.g., with shaped coils. However, in order to enable the externally manufactured preformed coils to be applied, the ‘tooth base’ would have to be adapted respectively to the tooth width.

The disclosure is not limited in its execution to the abovementioned preferred exemplary embodiments. Rather, a number of variants are conceivable that make use of the illustrated solution even in the form of fundamentally different embodiments. For example, the end shield 32 can also be integrally formed with the rotor bell 30.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An external rotor motor, comprising:
a stator with a stator lamination, a shaft which is attached in a non-rotatable manner and extends in the axial direction (A) of the motor, and a rotor bell which is arranged to rotate relative to the non-rotatable shaft;
the rotor bell is rotatably mounted on the shaft by at least one first stator-side bearing shield and a second rotor-side bearing shield;
the stator has a modular construction, including a plurality of individual teeth for attaching stator windings, the individual teeth are attached to one another in the direction of rotation and/or to a central stator body by a respective fastening contour, through which a fastening pin extends.

2. The external rotor motor as set forth in claim 1, wherein a slot, extending in the axial direction of the stator, is on at least one connecting side of the individual teeth, and a coupling web, corresponding to the cross-sectional shape of the slot, is on an opposing side, the web engages in a respective slot on a directly adjacent individual tooth in order to mechanically couple or fix these two individual teeth together.

3. The external rotor motor as set forth in claim 2, wherein groove slots, extending in the axial direction, are provided within the slot.

4. The external rotor motor as set forth in claim 3, wherein that, on the coupling webs, one or more web ears extend outward in the axial direction and are correspondingly shaped and positioned so that they engage in the respective groove slots when the respective coupling web engages in a corresponding slot.

5. The external rotor motor as set forth claim 1, wherein the individual teeth have a rib on a radially inwardly facing side that is used for connection to a cooling device that connects the individual teeth to the shaft.

6. The external rotor motor as set forth in claim 5, wherein the cooling device, arranged between the shaft and the stator lamination or the individual teeth, effects cooling when the motor rotates during operation by virtue of a fact that the cooling device has a multitude of axial flow openings that are arranged in the circumferential direction.

7. The external rotor motor as set forth in claim 1, wherein the individual teeth have a rectangular cross section.

8. The external rotor motor as set forth in claim 1, wherein the winding wires of the stator windings have a rectangular cross section in order to increase the fill factor.

9. The external rotor motor as set forth in claim 1, wherein the individual teeth have a recess on their front side facing outward in the direction of the air gap in the two regions facing toward the side edge of a tooth tip.

10. The external rotor motor as set forth in claim 1, further comprising a slot seal connecting two respective individual teeth, the slot seat is provided between each two individual teeth in a tip region in a vicinity of the slot openings, with the slot seal having a labyrinth contour as viewed in a cross-sectional direction.

11. The external rotor motor as set forth in claim 6, wherein the cooling device has an inner ring connecting the shaft as well as an outer ring connecting the stator lamination, and web-shaped connecting portions extending in the radial direction are formed integrally with the inner ring and the outer ring between which the flow openings are provided.
